(19) United States
(12) Patent Application Publication
(10) Pub. No.: US 2018/0106109 A1
(43) Pub. Date: Apr. 19, 2018

(54) ADJUSTABLE STEP LADDER SYSTEMS

(71) Applicant: GREGORY BOLLER, BALTIMORE, MD (US)

(72) Inventor: GREGORY BOLLER, BALTIMORE, MD (US)

(21) Appl. No.: 15/296,022

(22) Filed: Oct. 17, 2016

(51) Int. Cl. E06C 7/44; E06C 7/14; E06C 1/16

(52) U.S. Cl. CPC E06C 7/44; E06C 1/16; E06C 7/14

(57) ABSTRACT

An adjustable step ladder system including an adjustable step ladder assembly. The adjustable step ladder assembly includes a front-assembly, a rear-assembly, a top-unit, and a tray-unit in functional and structural combination. The front-assembly includes two front-legs, a plurality of rungs, and two front-feet in functional and structural combination. The rear-assembly includes two upper-legs, a center-section, two lower-legs, and two rear-feet in functional and structural combination. The tray-unit includes a tray, and two tracks in a preferred embodiment. The plurality of rungs are affixed between and to each of the front-legs such that the plurality of rungs provides a user with a secure step to climb the adjustable step ladder assembly.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of ladders and more specifically relates to adjustable step ladder systems.

### 2. Description of Related Art

Generally speaking, a step ladder is a set of rungs or steps which may be near-vertical or inclined. Most ladders are of two basic types; a ladder may be constructed of a single stringer and rest against a solid surface, or a ladder may be constructed of two stringers such that the ladder is self-supporting by forming a triangle-type shape thus forming an arrangement that is commonly referred to as a step ladder. Some ladders are made of metal, wood, or fiberglass, but they have also been known to be made of plastic or composites.

One such limitation with the common step ladder (of the self-supporting type, with dual stringers) is that they require a flat and solid surface to be safe and stable. Otherwise, the step ladder is rendered unsuitable for use. Some ladders with adjustable legs may be found, but such ladders allow adjustability to only by one stringer, such that they are not suitable to be positioned on stairs in a non-forward facing position.

Some common step ladders further include a top portion which allows the user to place tools or other work materials during work performed from the step ladder. These top portions are fixed to the top of the step ladder and do not allow the user with the ability to move the top portion to position the work materials in a more desirable and ergonomic position for work. Therefore it is desirable to provide an improved step ladder.

Several attempts have been made to solve the above-mentioned problems such as those found in U.S. Pat. No. 6,073,726 to McCrystal, U.S. Pat. No. 6,698,550 to Crain, U.S. Pat. No. 5,944,142 and U.S. Pat. No. 6,193,013 to Milner, U.S. Pat. No. 2,899,008 to Larson, U.S. Pat. No. 6,880,675 to Huang, U.S. Pat. No. 2,662,680 to Bronson, U.S. Pat. No. 5,265,698 to Freidel, Jr., U.S. Pat. No. 6,220,389 to Krause, and U.S. Pat. No. 2,692,076 to Demas et al. This art is representative of ladders. However, none of the above inventions and patents, taken either singly or in combination, is seen to describe the invention as claimed.

Preferably, an adjustable step ladder system should provide a device to allow an individual to work from a ladder upon a wide range of surfaces which are not level and, yet would operate reliably and be manufactured at a modest expense. Thus, a need exists for a reliable adjustable step ladder system to avoid the above-mentioned problems.

### BRIEF SUMMARY OF THE INVENTION

In view of the foregoing disadvantages inherent in the known ladder art, the present invention provides a novel adjustable step ladder system. The general purpose of the present invention, which will be described subsequently in greater detail is to provide a device with adjustable legs such that the device may be used on uneven surfaces (e.g., stairs, inclined/declined slopes, etc.).

Disclosed is a preferred embodiment of an adjustable step ladder system; the adjustable step ladder system comprising an adjustable step ladder assembly. The adjustable step ladder assembly comprises a front-assembly, a rear-assembly, a top-unit, and a tray-unit in functional and structural combination, in the preferred embodiment.

The front-assembly comprises and is defined by two front-legs, a plurality of rungs, and two front-feet in functional and structural combination. The rear-assembly comprises and is defined by two upper-legs, a center-section, two lower-legs, and two rear-feet in functional and structural combination and center section may further comprise cross-bracing to provide additional structural support, both laterally and vertically to the adjustable step ladder system. The tray-unit comprises a tray, and two tracks in a preferred embodiment.

Relationally speaking, the plurality of rungs are affixed between and to each of the front-legs such that the plurality of rungs provides a user with a secure step to climb the adjustable step ladder assembly. Additionally, the front-feet are each adjustably affixed to one of the front-legs, the upper-legs are adjustably affixed to the center-section, the center-section is adjustably affixed to each of the lower-legs, and each of the rear-feet are adjustably affixed to the lower-legs, in the preferred embodiment.

In continuing to refer to the preferred embodiment, the tray is slidably affixed to, and between, the tracks. The tracks are each affixed to one of the front-legs of the front-assembly and, additionally, one of the upper-legs of the rear-assembly. The tracks may be partially or fully removable such that the adjustable step ladder system may be folded for convenient transport and/or storage.

The front assembly and the rear-assembly are hingedly affixed to the top-unit such that the adjustable step ladder assembly is able to be folded into a position for ease of transport in the preferred embodiment. The front-assembly, the rear-assembly, the top-unit, and the tray-unit are structured and arranged in combination for providing a highly adjustable device useful for allowing the user to work in a stable and level position elevated from an unlevel surface.

The front-feet comprise a male-thread and the front-legs comprise a corresponding female-thread such that the front-feet are independently adjustable by twisting the front-feet in the preferred embodiment. Similarly, the rear-feet comprise a male-thread and the lower-legs comprise a corresponding female-thread such that the rear-feet are independently adjustable by twisting the rear-feet. In the preferred embodiment, the upper-legs are each adjustably affixed to the center-section via button-springs. Similarly, the center-section may adjustably affixed to the lower-legs via button springs in the preferred embodiment.

The preferred embodiment may include features such as a top unit coated with an anti-slip material to provide increased traction and safety to the user during use and/or treatments to the front-feet and the rear-feet further which include a rubberized-base to increase traction and further improve safety.

A kit is also described herein; the kit including: an adjustable step ladder assembly (comprising a front-assembly, a rear-assembly, a top-unit, and a tray-unit) as well as a set of user instructions.

The present invention holds significant improvements and serves as an adjustable step ladder system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, adjustable step ladder systems, constructed and operative according to the teachings of the present invention.

FIG. 1 shows a perspective view illustrating an adjustable step ladder system during an ‘in-use’ condition showing a user performing a task from the adjustable step ladder assembly according to an embodiment of the present invention.

FIG. 2 is a perspective view illustrating the adjustable step ladder system comprising an adjustable step ladder assembly positioned upon an uneven surface according to an embodiment of the present invention of FIG. 1.

FIG. 3 is a perspective view illustrating the feet, either the two front-feet or the two rear-feet, of the adjustable step ladder assembly according to an embodiment of the present invention of FIGS. 1-2.

FIG. 4 is a perspective view illustrating adjustable step ladder assembly according to an embodiment of the present invention of FIGS. 1-3.

FIG. 5 is a flowchart illustrating a method of use for an adjustable step ladder system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a ladder and more particularly to an adjustable step ladder system as used to improve the safety and reliability of step ladders for use on uneven surfaces such as stairs or inclined planes.

Generally speaking, adjustable step ladder system comprises an adjustable step ladder assembly, with the adjustable step ladder assembly comprising a front-assembly, a rear-assembly, a top-unit, and a tray-unit in functional and structural combination.

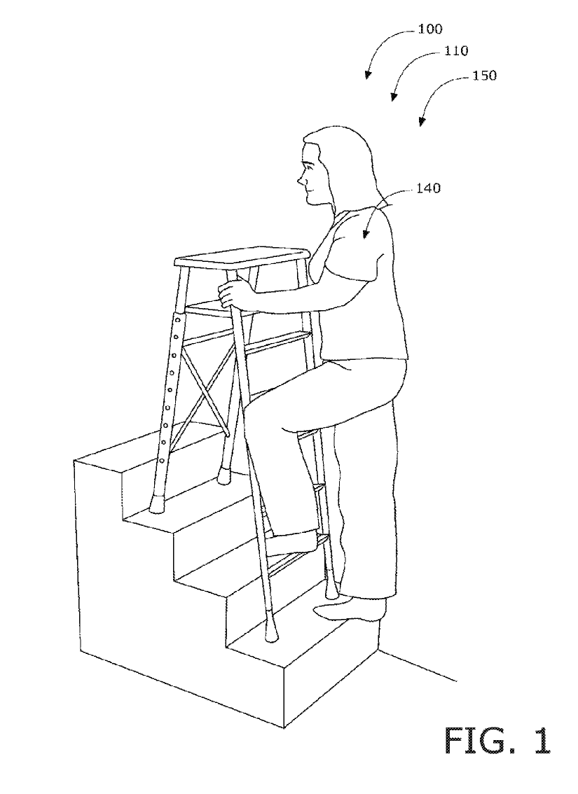

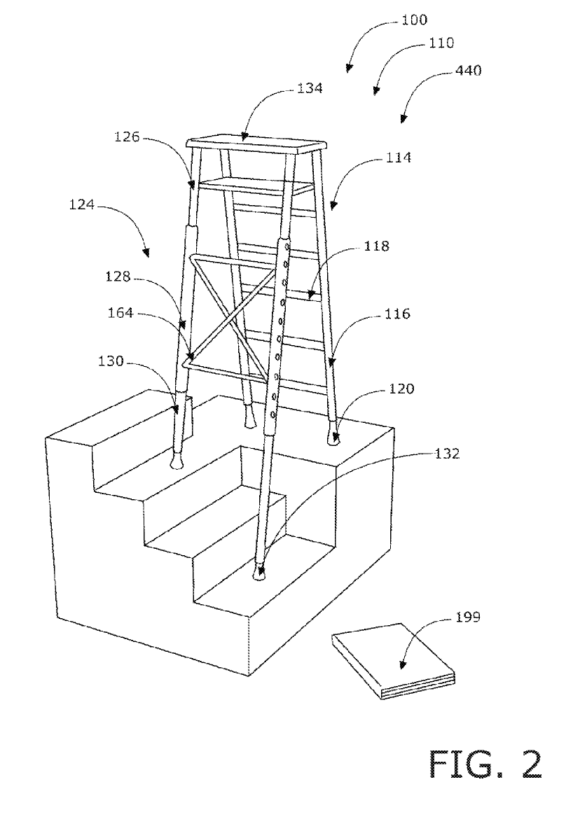

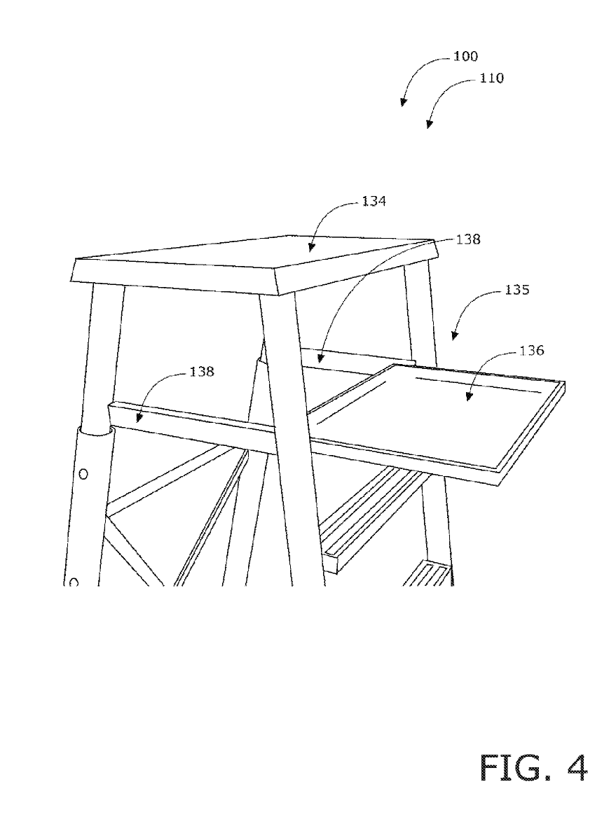

Referring to the drawings by numerals of reference there is shown in FIGS. 1-4, adjustable step ladder system 100 may be comprised of and defined by adjustable step ladder assembly 110, where adjustable step ladder assembly 110 may be comprised of (and defined by) front-assembly 114, rear-assembly 124, top-unit 134, and tray-unit 135.

Front-assembly 114 may be comprised of and defined by two front-legs 116, plurality of rungs 118 and two front-feet 120. Rear-assembly 124 may comprise, and be defined by, two upper-legs 126, center-section 128, two lower-legs 130, and two rear-feet 132. Some embodiments may include more or less front-legs 116, front-feet 120, lower-legs 130 and/or rear-feet 132, depending upon the specific application and/or preferences of user 140. Tray-unit 135 may comprise tray 136 and two tracks 138, with tracks 138 each affixed to one of front-legs 116 of front-assembly 114 and one of upper-legs 126 of rear-assembly 124. Tray 136 may be slidably affixed to, and between, tracks 138. Tracks 138 may be partially or fully removable such that the adjustable step ladder system 100 may be folded for convenient transport and/or storage.

Front-assembly 114, rear-assembly 124, top-unit 134, and tray-unit 135 are structured and arranged in combination for providing an highly adjustable device useful for allowing user 140 to work in a stable and level position elevated from an unlevel surface (e.g., upon stairs, inclined plane, unlevel ground, etc.).

Front-assembly 114 and rear-assembly 124 may be hingedly affixed to top-unit 134 such that adjustable step ladder assembly 110 is able to be folded into a position for ease of transport. Embodiments include plurality of rungs 118 affixed between each of front-legs 116 to provide user 140 with a secure step to climb adjustable step ladder assembly 110.

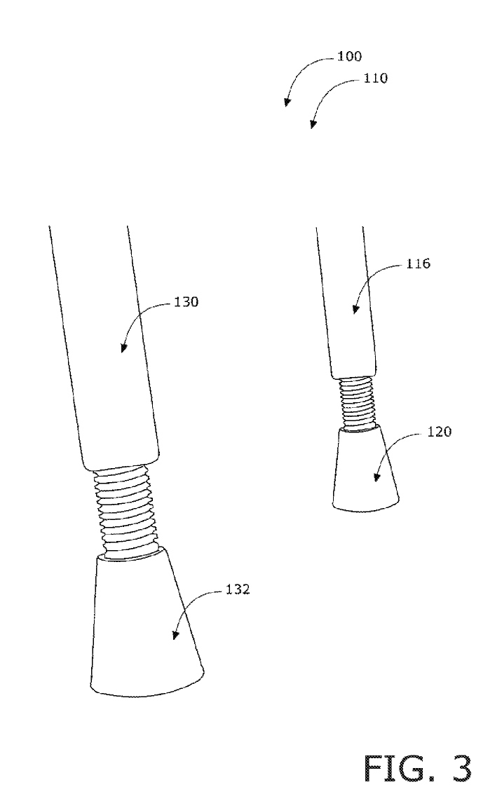

Each of front-feet 120 may be each adjustably affixed to one of front-legs 116; similarly each of rear-feet 132 may be adjustably affixed to each of lower-legs 130. In embodiments, front-feet 120 and/or rear-feet 132 may comprise a male-thread and front-legs 116 and/or lower-legs 130 may comprise a corresponding female-thread such that front-feet 120 and/or rear-feet 132 are independently adjustable by twisting front-feet 120 and/or rear-feet 132 to provide a ‘fine-adjustment’ (as shown in FIG. 3).

Upper-legs 126 may be adjustably affixed to center-section 128, and center-section 128 may be adjustably affixed to each of lower-legs 130. Center-section 128 may further include cross-bracing 164 to provide additional structural support, both laterally and vertically, to the adjustable step ladder system 100. Center-section may 128 be adjustably affixed to lower-legs 130 via removable pins, biasers, or via button springs, depending upon the embodiment.

In some embodiments, upper-legs may be each adjustably affixed to center-section via removable pins; other embodiments may include upper-legs each adjustably affixed to center-section via one or more biasers. Further embodiments may include upper-legs each adjustably affixed to center-section via button-springs. Other embodiments may include other fasteners as desired.

In order to improve safety and functionality, top-unit 134 may be coated with an anti-slip material to provide increased traction and safety to user 140 during use. Additional safety and functionality features may include front-feet 120 and rear-feet 132 which further include a rubberized-base to increase traction. Rungs 118 may be coated with an anti-slip material to further enhance safety and functionality.

Materials of manufacture for adjustable step ladder system 100 may vary depending upon the specific application and user preferences. In such, adjustable step ladder assembly 110 may constructed from an aluminum alloy to be lightweight for carrying, may be constructed from a steel-alloy to provide longevity and durability, or may be constructed from a fiberglass-material such that adjustable step ladder assembly 110 is not electrically conductive to provide additional safety for user 140. It should be noted that materials of manufacture for adjustable step ladder system 100 are not limited to the aforementioned materials.

It should be noted that adjustable step ladder system 100 may be sold as kit 440 comprising the following parts: at least one adjustable step ladder assembly 110 (comprising front-assembly 114, rear-assembly 124, top-unit 134, and tray-unit 135); and at least one set of user instructions 199. The kit has instructions such that functional relationships are detailed in relation to the structure of the invention (such that the invention can be used, maintained, or the like in a preferred manner). Adjustable step ladder system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

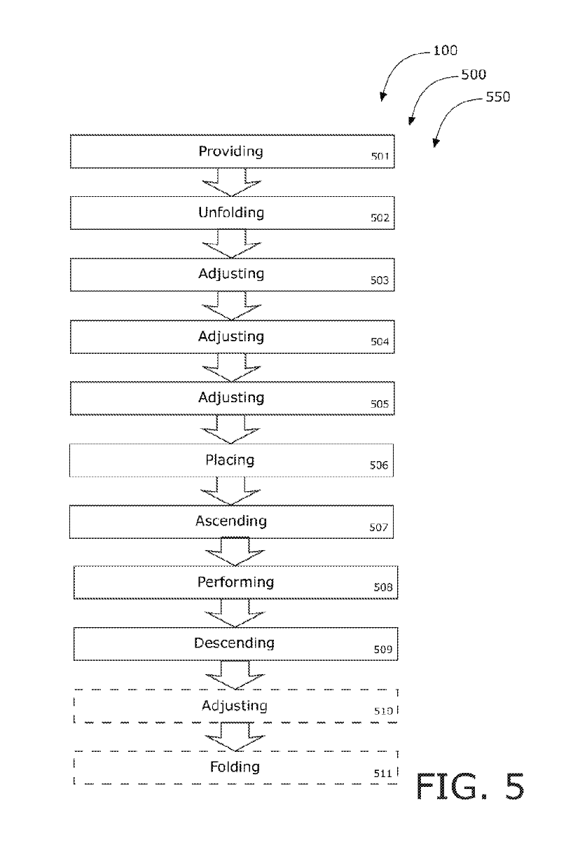

Referring now to FIG. 5 showing flowchart 550 illustrating method of use 500 for adjustable step ladder system 100 according to an embodiment of the present invention of FIGS. 1-4.

As shown, method of use 500 may comprise the steps of: step one 501, providing adjustable step ladder system 100; step two 502, unfolding adjustable step ladder system 100; step three, 503 adjusting upper-legs 126 of the adjustable step ladder system 100 to a desired position; step four 504, adjusting center-section 128 of adjustable step ladder system 100 to a desired position; step five 505, adjusting front-feet 120 and rear-feet 132 of adjustable step ladder system 100 to a desired position; step six 506, placing front-feet 120 and rear-feet 132 of adjustable step ladder system 100 on one or more surfaces; step seven 507, ascending adjustable step ladder system 100; step eight 508, performing one or more tasks from adjustable step ladder system 100, step nine 509, descending adjustable step ladder system 100; step ten 510, adjusting upper-legs 126 and center-section 128 to a minimum position; and step eleven 511, folding adjustable step ladder system 100 for ease of transport and storage.

It should be noted that step ten 510 and step eleven 511 are optional steps and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. § 112, 916. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An adjustable step ladder system comprising:
an adjustable step ladder assembly comprising;
a front-assembly comprising;
two front-legs;
a plurality of rungs; and
two front-feet;
a rear-assembly comprising;
two upper-legs;
a center-section;
two lower-legs; and
two rear-feet;
a top-unit; and
a tray-unit comprising;
a tray; and
two tracks;
wherein said adjustable step ladder system comprises said adjustable step ladder assembly;
wherein said adjustable step ladder assembly comprises said front-assembly, said rear-assembly, said top-unit, and said tray-unit in functional combination;
wherein said front-assembly comprises and is defined by said front-legs, said plurality of rungs, and said front-feet;
wherein said rear-assembly comprises and is defined by said upper-legs, said center-section, said lower-legs, and said rear-feet;
wherein said tray-unit comprises and is defined by said tray and said tracks;
wherein said plurality of rungs are affixed between each of said front-legs to provide a user with a secure step to climb said adjustable step ladder assembly;
wherein said front-feet are each adjustably affixed to one of said front-legs;
wherein said upper-legs are adjustably affixed to said center-section;
wherein said center-section is adjustably affixed to each of said lower-legs;
wherein each of said rear-feet are adjustably affixed to said lower-legs;
wherein said tray is slidably affixed to, and between, said tracks;
wherein said tracks are each affixed to one of said front-legs of said front-assembly and one of said upper-legs of said rear-assembly;
wherein said front-assembly and said rear-assembly are hingeldy affixed to said top-unit such that said adjustable step ladder assembly is able to be folded into a position for ease of transport; and
wherein said front-assembly, said rear-assembly, said top-unit, and said tray-unit are structured and arranged in combination for providing an highly adjustable device useful for allowing said user to work in a stable and level position elevated from an unlevel surface.

2. The adjustable step ladder system of claim 1 wherein said front-feet comprise a male-thread and said front-legs comprise a corresponding female-thread such that said front-feet are independently adjustable by twisting said front-feet.

3. The adjustable step ladder system of claim 1 wherein said rear-feet comprise a male-thread and said lower-legs comprise a corresponding female-thread such that said rear-feet are independently adjustable by twisting said rear-feet.

4. The adjustable step ladder system of claim 1 wherein said upper-legs are each adjustably affixed to said center-section via removable pins.

5. The adjustable step ladder system of claim 1 wherein said upper-legs are each adjustably affixed to said center-section via one or more biasers.

6. The adjustable step ladder system of claim 1 wherein said upper-legs are each adjustably affixed to said center-section via button-springs.

7. The adjustable step ladder system of claim 1 wherein of said center-section further comprises cross-bracing to provide additional structural support, both laterally and vertically, to said adjustable step ladder system.

8. The adjustable step ladder system of claim 1 wherein said center-section is adjustably affixed to said lower-legs via removable pins.

9. The adjustable step ladder system of claim 1 wherein said center-section is adjustably affixed to said lower-legs via one or more biasers.

10. The adjustable step ladder system of claim 1 wherein said center-section is adjustably affixed to said lower-legs via button-springs.

11. The adjustable step ladder system of claim 1 wherein said top unit is coated with an anti-slip material to provide increased traction and safety to said user during use.

12. The adjustable step ladder system of claim 1 wherein said front-feet and said rear-feet further comprise a rubberized-base to increase traction and improve safety.

13. The adjustable step ladder system of claim 1 wherein said rungs are coated with an anti-slip material to provide increased traction and safety to said user during use.

14. The adjustable step ladder system of claim 1 wherein said adjustable step ladder assembly is constructed from an aluminum alloy to be lightweight for carrying.

15. The adjustable step ladder system of claim 1 wherein said adjustable step ladder assembly is constructed from a steel-alloy to provide longevity and durability.

16. The adjustable step ladder system of claim 1 wherein said adjustable step ladder assembly is constructed from a fiberglass-material such that said adjustable step ladder assembly is not electrically conductive to provide additional safety for said user.

17. An adjustable step ladder system comprising:
an adjustable step ladder assembly comprising;
a front-assembly comprising;
two front-legs;
a plurality of rungs; and
two front-feet;
a rear-assembly comprising;
two upper-legs;
a center-section;
two lower-legs; and
two rear-feet;
a top-unit; and
a tray-unit comprising;
a tray; and
two tracks;
wherein said adjustable step ladder system comprises said adjustable step ladder assembly;
wherein said adjustable step ladder assembly comprises said front-assembly, said rear-assembly, said top-unit, and said tray-unit in functional combination;
wherein said front-assembly comprises and is defined by said front-legs, said plurality of rungs, and said front-feet;
wherein said rear-assembly comprises and is defined by said upper-legs, said center-section, said lower-legs, and said rear-feet;
wherein said tray-unit comprises and is defined by said tray and said tracks;
wherein said plurality of rungs are affixed between each of said front-legs to provide a user with a secure step to climb said adjustable step ladder assembly;
wherein said front-feet are each adjustably affixed to one of said front-legs;
wherein said upper-legs are adjustably affixed to said center-section;
wherein said center-section is adjustably affixed to each of said lower-legs;
wherein each of said rear-feet are adjustably affixed to said lower-legs;
wherein said tray is slidably affixed to, and between, said tracks;
wherein said tracks are each affixed to one of said front-legs of said front-assembly and one of said upper-legs of said rear-assembly;
wherein said front assembly and said rear-assembly are hingeldy affixed to said top-unit such that said adjustable step ladder assembly is able to be folded into a position for ease of transport; and
wherein said front-assembly, said rear-assembly, said top-unit, and said tray-unit are structured and arranged in combination for providing an highly adjustable device useful for allowing said user to work in a stable and level position elevated from an unlevel surface.
wherein said front-feet comprise a male-thread and said front-legs comprise a corresponding female-thread such that said front-feet are independently adjustable by twisting said front-feet.
wherein said rear-feet comprise a male-thread and said lower-legs comprise a corresponding female-thread such that said rear-feet are independently adjustable by twisting said rear-feet.
wherein said upper-legs are each adjustably affixed to said center-section via button-springs.
wherein of said center-section further comprises cross-bracing to provide additional structural support, both laterally and vertically to said adjustable step ladder system.
wherein said center-section is adjustably affixed to said lower-legs via button springs.
wherein said top-unit is coated with an anti-slip material to provide increased traction and safety to said user during use.
wherein said front-feet and said rear-feet further comprise a rubberized-base to increase traction and improve safety.
wherein said rungs are coated with an anti-slip material to provide increased traction and safety to said user during use.
wherein said adjustable step ladder assembly is constructed from a fiberglass-material such that said adjustable step ladder assembly is not electrically conductive to provide additional safety for said user.

18. The adjustable step ladder system of claim 17 further comprising a kit including:
an adjustable step ladder assembly comprising;
a front-assembly;
a rear-assembly;
a top-unit; and
a tray-unit; and
a set of user instructions.

19. A method of using an adjustable step ladder system comprising the steps of:
providing an adjustable step ladder system;
unfolding said adjustable step ladder system;
adjusting two upper-legs of said adjustable step ladder system to a desired position;
adjusting a center-section of said adjustable step ladder system to a desired position;
adjusting two front-feet and two-rear feet of said adjustable step ladder system to a desired position;
placing said front-feet and said rear-feet of said adjustable step ladder system on one or more surfaces;
ascending said adjustable step ladder system;
performing one or more tasks from said adjustable step ladder system; and
descending said adjustable step ladder system.

20. The method of claim 19 further comprising the steps of:
adjusting said upper-legs and said center-section to a minimum position; and
folding said adjustable step ladder system for ease of transport and storage.
